(19) United States
(12) Patent Application Publication
(10) Pub. No.: US 2002/0023481 A1
(43) Pub. Date: Feb. 28, 2002

(54) Apparatus and method for determining the presence of air leaks in a charge air cooler

(76) Inventor: William W. Wagner, Prescott, AZ (US)

Correspondence Address: BIRCH STEWART KOLASCH & BIRCH, PO BOX 747, FALLS CHURCH, VA, 22040-0747, US

(21) Appl. No.: 09/924,441

(22) Filed: Aug. 9, 2001

Related U.S. Application Data
(60) Provisional application No. 60/223,978, filed on Aug. 9, 2000.

(51) Int. Cl. G01M 3/08

(52) U.S. Cl. 73/40.5 R

(57) ABSTRACT

A testing apparatus is used for determining the existence of air leaks in a charge air cooler having inlet and outlet conduits. The apparatus includes a first canister for closing one of the conduits, and a flexible tubular conduit for surrounding and engaging that one of the conduits and the first canister and being secured thereto and establishing a fluid tight communication between the first canister and that one of the conduits. The apparatus further includes a second canister for closing the other of the conduits, and a flexible tubular conduit for surrounding and engaging the other of the conduits and the second canister and being secured thereto and establishing a fluid tight communication between the second canister and the other of the conduits. One of the canisters has a pressurized air inlet fitting, an air pressure shutoff valve, and a device for measuring the air pressure in the canister.

This nonprovisional application claims priority under 35 U.S.C. § 119(e) on U.S. Provisional Application No. 60/223,978, filed on Aug. 9, 2000, which is herein incorporated by reference.

### BACKGROUND OF THE INVENTION

1. Field of the Invention

This invention relates to an apparatus for determining whether a charge air cooler is leak-free during operation of an engine. More particularly, the invention relates to an apparatus for determining whether a charge air cooler of the type as used on a turbo charged diesel engine is free of leaks or needs to be repaired or replaced. In addition, this invention relates to a method for determining whether air leakage is occurring in a charge air cooler during its use on an engine. More particularly, the invention relates to a method and apparatus for determining whether air leaks are present in a charge air cooler without the need of removing the charge air cooler from the engine.

2. Description of the Background Art

Diesel engines are commonly used as power plants for applications in which significant power is needed at a relatively low cost of operation. Such engines are often used in large earth moving equipment as well as on-road trucks and road tractors, agricultural equipment, generator sets and other common industrial applications. More recently, increased emphasis on reducing exhaust emissions from diesel engines has led to new developments to help reduce emissions from such engines. For example, turbochargers help improve both the efficiency and power output of diesel engines, and thus achieve a reduction in emission levels. Still more recently, systems known as charge air coolers have been developed to improve the efficiency of turbocharged engines.

Charge air cooler systems are heat exchangers which serve to cool the air charge used for combustion in turbocharged diesel engines after it has been compressed but before it enters the combustion chambers. Thus, these charge air coolers receive the compressed high pressure hot air directly from the output of the turbocharger, and cool that air before it is admitted into the engine for the combustion process. These charge air coolers use ambient air in a heat exchange relationship with the compressed combustion air to cool the combustion air. The cooled, pressurized air is therefore more dense and greatly improves the combustion efficiency of the engine.

Charge air coolers however are subject to much greater stress, both thermal stress and mechanical stress, than is ordinarily encountered in automotive power systems. Typically, the charge air cooler receives air at its inlet at a temperature on the order of 350-400° F., and must cool that air to about 35-40° F. above ambient temperature, or about 100-110° F. Thus, there is a temperature differential of about 240-300° F. between the inlet and outlet. Moreover, the operating pressure generally is on the order of about 35-40 psi (pounds per square inch) because the air is compressed by the turbocharger.

Because of these severe operating conditions, the charge air cooler operates under much greater stress than a conventional heat exchanger or radiator, such as the type used to cool the engine coolant. Because the temperature gradient across the unit is so large, thermal coefficients of expansion can introduce great differential expansion factors into the unit, and at pressures of two to three atmospheres, coupled with the vibrations caused by even normal engine operation, leaks can easily and frequently occur, for example, at welds in the charge air coolers.

Typically, charge air coolers are factory tested to a standard such that pressure loss does not exceed 5 psi in 15 seconds when pressurized to 25-30 psi. Extensive testing has revealed that in charge air coolers, a sufficient to cause a pressure loss of 5 psi in 15 seconds when pressurized to only 30 psi, can cause a power loss of up to 15 horsepower. Units which do not meet such standards are in need of replacement.

So far as known, however, there is no method or apparatus for testing charge air coolers while they are installed on the engine other than using soapy water to detect air bubbles while the engine is running. However, a vibrating engine operating in the presence of a cooling fan makes it very difficult to detect the existence of leaks in a charge air cooler. Original factory testing is, of course, done with the unit removed from an engine, and thus is not subjected to these conditions.

Because a charge air cooler is an expensive component, determination of a leaking charge air cooler is important, but has heretofore been very difficult to achieve. Often, a charge air cooler in which leakage was suspected would simply be replaced or removed for repair. In practice, because of lost operating time, the charge air cooler was often merely replaced.

### SUMMARY AND OBJECTS OF THE INVENTION

Accordingly, a primary object of this invention is to provide an apparatus for the easy determination of an air leak in a charge air cooler.

Another object of the invention is to provide a reliable method for determining the existence of an air leak in a charge air cooler.

Still another object is to provide a device which can be easily attached to a charge air cooler while it is still in the motor vehicle in order to determine whether the charge air cooler is leaking.

A further object is to provide an apparatus into which pressurized air, of up to about 40 psi, is admitted, and from which an air pressure drop can then be measured.

Yet another object is to provide a device of the type described which can be safely used with a pressurized charge air cooler.

A further object is to provide a method and apparatus that is easy, fast, safe and relatively inexpensive to use.

The present invention provides a method and an apparatus for detecting the presence of air leaks in a charge air cooler. The apparatus comprises first and second canisters. The first canister is connectable to the inlet conduit or neck of the charge air cooler so as to be in fluid tight communication therewith, and includes an inlet fitting for admitting pressurized air, an air pressure shutoff valve, and a gauge for measuring the air pressure inside the canister and thus inside the charge air cooler. The second canister serves to close the outlet conduit or neck of the charge air cooler. It is similar to the first canister, but does not have an air inlet or air gauge. Each canister is securely attached to its respective conduit.

Since the air pressure within the apparatus will reach pressures on the order of 40 psi, each canister is further secured to its respective conduit by a safety mechanism which connects the canister to a retention collar by a chain, and each retention collar is secured to the respective conduit or neck by a locking screw or set screw.

The method comprises providing a first canister which includes a pressurized air inlet fitting, an air pressure shutoff valve, and a gauge for measuring the air pressure inside the canister and the charge air cooler, and attaching the first canister to either the inlet or outlet conduit of the charge air cooler. A second canister is provided and attached to the other of the conduits of the charge air cooler, thereby closing the air passageway system at both the inlet and outlet ends. A fluid tight connection between the canister and respective conduit is assured by a flexible connecting sleeve or hose which is fitted over both the canister and the conduit and secured to each by hose clamps.

Each canister is also secured to its respective conduit by a retention collar which is secured to that conduit by a set screw or locking screw, and is also connected by a chain to the canister. Because of the high pressure involved with charge air coolers, if the canisters were not adequately restrained, serious injury could result from a canister being blown off of the charge air cooler fitting. However the retention collar system as described ensures that should the canister come loose from the flexible sleeve, its sudden release would be restrained by the retention collar and the securing chain.

To determine if a charge air cooler has an air leak, pressurized air is introduced into the system through the pressurized air inlet fitting. The air pressure within the system is increased to 40 psi, and the air valve is closed. A first reading of the level of the air pressure is taken. The system is then allowed to stand in this pressurized state for a predetermined period of time, for example 15 seconds, in order to detect a loss of air pressure. Then a second reading of the level of the air pressure is taken, and the first and second readings are compared. Any loss of air pressure during this predetermined period of time would indicate an air leak in the charge air cooler, for example at a weld joint. The pressure loss may be read directly from a gauge, or an electronic sensor could be used which could signal an alarm. If the pressure remains constant, no leak is present. However, if leaks are present, the pressure will drop. Soapy water may be applied around the charge air cooler if desired, and the appearance of bubbles will pinpoint the location of the leak or leaks.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an exploded schematic view of the apparatus for determining the existence of air leaks in charge air coolers; and

FIG. 2 is a schematic view of the apparatus in an assembled configuration for determining the existence of air leaks in charge air coolers.

### DETAILED DESCRIPTION OF THE PREFERRED EMBODIMENT

As shown in the drawings, the apparatus generally designated 10 is shown and includes a first canister 12 provided with a pressurized air inlet fitting 14, an air pressure shutoff valve 16, and an air pressure gauge 18. A chain 20 is attached to the canister 12, for example by welding, and to a safety retention collar 22 by a screw 21 or by welding. The safety retention collar 22 is placed over the inlet conduit 24 of the charge air cooler 26 being tested and is held firmly in place by a set screw 28 which is tightened securely against the inlet conduit 24. A short piece of reinforced, flexible hose 30 is used to connect the canister 12 to the inlet conduit 24. The hose 30 is provided with hose clamps 32,34, each having a hose clamp screw 36,38. The open end of the canister 12 has one or more peripheral lips or ribs 40 which is fitted securely into one end of the hose 30 and helps to seal and retain the connection. The first hose clamp 32 secures the hose 30 to the canister 12 above the rib 40 when the hose clamp screw 36 is tightened. The second end of the hose 30 is fitted securely over the end of the inlet conduit 24 of the charge air cooler 26. The second hose clamp 34 is tightened by turning a hose clamp screw 38 thereby securing the hose 30 to the inlet conduit 24.

A second safety retention collar 42, similar to collar 22, is placed over the outlet conduit 44 of the charge air cooler 26, and is tightened securely to the conduit 44 by a set screw 46. The safety retention collar 42 is held to a second canister 48 by a chain 50, in the same manner as with first canister 12. A short length of hose 52 is used to connect the canister 48 to the outlet conduit 44. One end of the hose 52 is fitted over the outlet conduit 44, and held firmly in place by tightening a hose clamp screw 54 on a third hose clamp 56. The other end of the hose 52 is fitted over the peripheral ribs or lips 58 of the canister 48, and is held firmly in place by tightening a hose clamp screw 60 on a fourth hose clamp 62.

In operation, each canister 12, 48 is tightly and securely connected to the respective inlet conduit 24 and outlet conduit 44 of the charge air cooler 26. The air pressure shutoff valve 16 is opened, and pressurized air is introduced into the system through the pressurized air inlet fitting 14 until the desired air pressure, generally 25-40 psi, is read on the air pressure gauge 18. The air supply is then turned off by closing off the air pressure shutoff valve 16.

The charge air cooler 26 is thus pressurized to the pressure indicated on the valve 16 and allowed to stand for a predetermined period of time, for example 15 seconds, in order to detect a drop in pressure on the gauge 18 indicating an air leak. If no pressure drop occurs, the unit is within tolerance and usable. While present standards indicate measuring pressure drop over a time period of 15 seconds, clearly the apparatus could be used to measure a greater or lesser pressure drop over a greater or shorter period of time.

The invention has been described in relation to inlet and outlet conduits, and it will be readily appreciated that the canisters may be reversed, i.e. by securing the inlet canister 12 to the outlet conduit 44, without affecting the use of the device or the method.

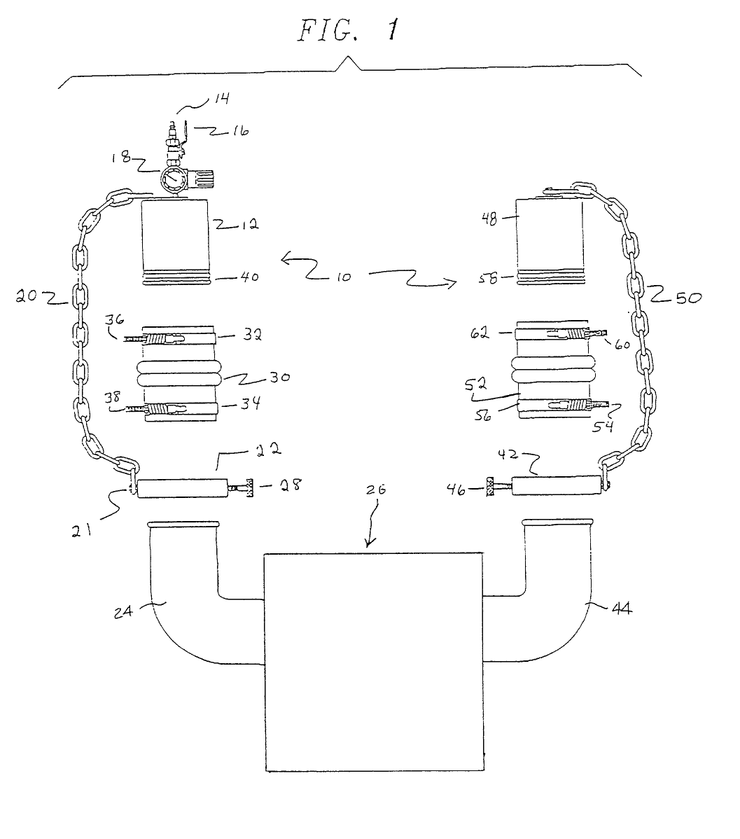

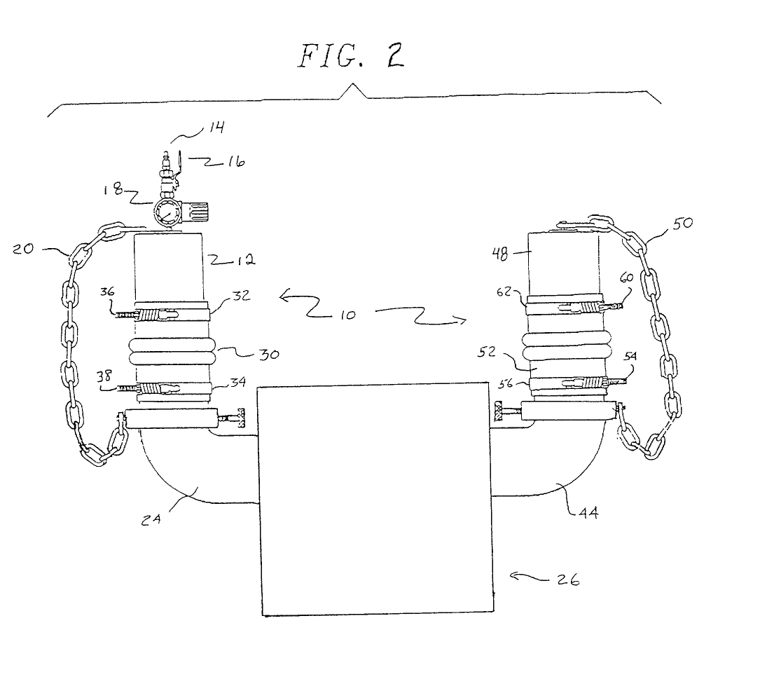

While the preferred embodiment shown in FIGS. 1 and 2 utilizes first and second canisters 12, 48, it should be understood that other devices may be utilized to close the ends of the inlet and outlets of the charge air cooler. For example, a plug-type closure or stopper may be used which fits inside of the end of the inlet (or outlet) of the charge air cooler, instead of using canister 48 and hose 52. The plug-type closure may be force-fitted into the inlet (or outlet), or may be formed as an inflatable air bladder which is inflated to provide an air-tight seal with the inlet (or outlet). The alternative plug-type closure may preferably be used with the safety retention collar 42 and the chain 50, although use without the safety retention collar 42 and the chain 50 is envisioned. Further, other types of safety members may be utilized in place of the chains 20, 50, such as belts, wires, cables, straps and other flexible members. The safety members, including the chains 20, 50, are preferably inelastic, but it is envisioned that partly elastic members may also be utilized.

In addition, it is envisioned that the canister 12 and the hose 30 may be formed as a unitary one-piece member, instead of being formed as separate pieces joined together and held by hose clamps. The canister 48 and the hose 52 may also be formed as a unitary one-piece member.

Finally, while the gauge 18 is shown as being located on the first canister 12 with the air inlet fitting 14 and the air pressure shutoff valve 16, it is envisioned that the gauge 18 may be located on the second canister 48 separate from the air inlet fitting 14 and the air pressure shutoff valve 16.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A testing apparatus for determining the existence of air leaks in a charge air cooler having first and second conduits, the apparatus comprising:
a first closure for closing the first conduit and establishing a fluid tight seal between said first closure and the first conduit, said first closure including an air inlet fitting and an air pressure shutoff valve;
a second closure for closing the second conduit and establishing a fluid tight seal between said second closure and the second conduit; and
a pressure measuring device attached to one of said first closure and said second closure for measuring the air pressure in the charge air cooler.

2. The testing apparatus according to claim 1, wherein said first closure comprises a first canister and a first flexible tubular conduit for surrounding and engaging said first canister and the first conduit.

3. The testing apparatus according to claim 2, further comprising a first clamp for securing one end of said first flexible tubular conduit to said first canister, and a second clamp for securing another end of said first flexible tubular conduit to the first conduit.

4. The testing apparatus according to claim 2, wherein said second closure comprises a second canister and a second flexible tubular conduit for surrounding and engaging said second canister and the second conduit.

5. The testing apparatus according to claim 1, wherein said first closure comprises a first resilient cap for surrounding and engaging the first conduit.

6. The testing apparatus according to claim 5, wherein said second closure comprises a second resilient cap for surrounding and engaging the second conduit.

7. The testing apparatus according to claim 1, wherein said pressure measuring device is an air pressure gauge.

8. The testing apparatus according to claim 7, wherein said air pressure gauge is attached to said first closure.

9. The testing apparatus according to claim 1, further comprising a safety retention device for retaining said first closure to the charge air cooler in the event of failure of said first closure to remain adequately secured to the first conduit.

10. The testing apparatus according to claim 9, wherein said safety retention device comprises a safety collar, means for securing said safety collar to the charge air cooler, and means for securing said safety collar to said first closure.

11. The testing apparatus according to claim 10, wherein said means for securing said safety collar to the charge air cooler is a threaded screw.

12. The testing apparatus according to claim 11, wherein said means for securing said safety collar to said first closure is a flexible, inextensible member having a first end attached to said safety collar and a second end attached to said first closure.

13. The testing apparatus according to claim 12, wherein said flexible, inextensible member is a chain.

14. A testing apparatus for determining the existence of air leaks in a charge air cooler having inlet and outlet conduits, the apparatus comprising:
a first canister connectable to the inlet conduit for sealing the inlet conduit against the loss of fluid pressure;
a second canister connectable to the outlet conduit for sealing the outlet conduit against the loss of fluid pressure;
one of said first and second canisters including an air inlet fitting and an air shutoff valve; and
one of said first and second canisters including an air pressure measuring device.

15. The testing apparatus according to claim 14, further comprising:
a first flexible tubular conduit for surrounding and engaging said first canister and the inlet conduit; and
a second flexible tubular conduit for surrounding and engaging said second canister and the outlet conduit.

16. The testing apparatus according to claim 15, further comprising:
a first pair of clamps for securing said first flexible tubular conduit to said first canister and said inlet conduit; and
a second pair of clamps for securing said second flexible tubular conduit to said second canister and said outlet conduit.

17. The testing apparatus according to claim 16, further comprising a pair of safety retention members for retaining said first canister and said second canister in attachment with the charge air cooler.

18. The testing apparatus according to claim 17, wherein said safety retention members each comprise:
a safety collar securable to the charge air cooler; and
a flexible, inextensible member having a first end attached to said safety collar and a second end attached to a respective one of said canisters.

19. A method for determining the existence of air leaks in a charge air cooler having a first conduit and a second conduit, said method comprising the steps of:
sealing the first conduit of the charge air cooler in an air tight manner with a first closure;
sealing the second conduit of the charge air cooler in an air tight manner with a second closure;
providing an air inlet fitting and an air shutoff valve in one of said first and second closures;
providing an air pressure gauge in one of said first and second closures;
introducing pressurized air into the charge air cooler through said air inlet fitting;
pressurizing the charge air cooler to a predetermined level;
closing said air shutoff valve to discontinue the introduction of pressurized air into the charge air cooler;
obtaining a first reading of the air pressure within the charge air cooler from said air pressure gauge;
allowing the charge air cooler to stand for a predetermined period of time;
obtaining a second reading of the air pressure within the charge air cooler from said air pressure gauge; and
comparing said first and second readings to determine whether a difference in readings exists as an indication of the existence of a leak in said charge air cooler.

20. The method according to claim 19, further comprising the steps of:
securing said first closure to said first conduit using a first flexible connecting conduit; and
securing said second closure to said second conduit using a second flexible connecting conduit.
